(19) United States
(12) Patent Application Publication
(10) Pub. No.: US 2011/0153590 A1
(43) Pub. Date: Jun. 23, 2011

(54) APPARATUS AND METHOD FOR SEARCHING FOR OPEN API AND GENERATING MASHUP BLOCK SKELETON CODE

(75) Inventors: Yoon-Seop Chang, Daejeon (KR); Seong-Ho Lee, Daejeon (KR); Jae-Chul Kim, Daejeon (KR); Jae-Jin Yoo, Daejeon (KR); Sun-Rae Park, Daejeon (KR); Chang-Rak Yoon, Daejeon (KR); Hak-Cheol Kim, Daejeon (KR); Ki-Jung Lee, Yongin-si (KR); Kyung-Ok Kim, Daejeon (KR); Jong-Hyun Park, Daejeon (KR)

(73) Assignee: ELECTRONICS AND TELECOMMUNICATIONS RESEARCH INSTITUTE, Daejeon (KR)

(21) Appl. No.: 12/970,310

(22) Filed: Dec. 16, 2010

(30) Foreign Application Priority Data
Dec. 18, 2009 (KR) 10-2009-0127065
Apr. 29, 2010 (KR) 10-2010-0040122

(51) Int. Cl. G06F 17/30

(52) U.S. Cl. 707/711; 707/E17.116

(57) ABSTRACT

The present invention relates to an apparatus and a method for searching for an open API and generating a mashup block skeleton code. A method for searching for an open API and generating a mashup block skeleton code includes: storing metadata of web services and open APIs according to an integrated schema; searching for a web service or an open API corresponding to search query input from a user; extracting the metadata necessary to generate the skeleton code of the metadata of the mashup block by using the mapping relationship between the meta data of the searched web service or the searched open API and the metadata of the mashup block; and generating the skeleton code of the metadata of the mashup block by using the extracted metadata.

### RELATED APPLICATIONS

The present application claims priority to Korean Patent Application Number 10-2009-0127065, filed on Dec. 18, 2009, and 10-2010-0040122, filed on Apr. 29, 2010, the entirety of which is hereby incorporated by reference.

### BACKGROUND OF THE INVENTION

1. Field of the Invention

The present invention relates to an apparatus and a method for searching for an open API (Application Programming Interface) and generating a mashup block skeleton code. More particularly, the present invention relates to a method and an apparatus capable of integrally searching for a web service and an open API by using an integrated schema in a single search system and generating a skeleton code of a metadata of a corresponding mashup block by using similarity between the integrated schema for the web service and the open API and a metadata schema of a mashup block.

2. Description of the Related Art

A need to manage web services has increased with the expansion of services through the Internet. The web services are software services. In other words, as the services provided by a software module, there may be, for example, a translation service that translates English text file into Chinese text file, and the like.

As the most widely known web service managing scheme, there is a universal description, discovery and integration (UDDI) based registry. The UDDI opens information on the web services, which is the standard for searching the services. This standard uses an information framework for description and classification of information such as web services and uses interfaces for web services.

However, the UDDI based web services have some problems.

First, the UDDI based accessing scheme is necessary to use the UDDI-based database. Thereby, many small service providers are reluctant to use the UDDI based registry due to increase in costs.

Further, the UDDI based web services are not detected by general purpose search engines (for example, Google). The reason is that the service suppliers register the services in a UDDI based registry in order to open services and the user searches for the UDDI database of the registry in order to search for the services. Although the web-based interface is provided to perform the search, the general purpose search engine cannot directly access or search for the UDDI database.

Further, the UDDI uses a web services description language (WSDL) to describe the interface for the web services. This makes it difficult for a user to search and select for the services. When the user needs to use the services, the reason is that he/she generally describes the purpose and/or function of the services is to search for the services.

However, the service publication using the WDSL generally defines only the service invocation interfaces but does not describe the purpose or function of the services, such that it is difficult for a user to use the WDSL.

In addition, when selecting the service using the UDDI, the user should often consider other factors such as costs, security, customer support, performance, resource consumption, and the like. Although the UDDI based web service registries include some of the information, it is not easy to access the registries such that it is more difficult to use and accept the services. In addition, the UDDI based registries provide a mechanism for publishing and uploading the services to the service providers but does not provide means that can determine feedback, evaluation, and grade for the services by the user.

Consequently, the existing services often disappoint the users in addition to requiring significant time and effort to select useful services from the UDDI data base.

Recently, in order to enable the WDSL based web service search by a general purpose search engine, attempts to use really simple syndicate (RSS) (used for distributing content) have been conducted. In the attempts, the URL of the service WDSL file is embedded as one item of the RSS feed, which can be detected by the general purpose search engines. However, for the RSS based web service search, the user should have an RSS reader and collector on the access device and should join in the RSS feed. Thereby, when the change occurs in the feed, the occurred change is supplied to the user apparatus. Although the user can feedback the service provided by the RSS based web service search, it cannot easily configure the feedback by the accessing scheme and it is not easy to link the services corresponding to the feedback of the user in order to easily perform an access in selecting the desired services. Further, the user cannot describe the purpose and function of the service under the mechanisms.

Therefore, the development of the method and system for searchable web services is required in order to solve the above problems.

In particular, a technology of integration search using the same description type for the web service and the open application programming interface (API) as in the present invention is insignificant. Although there are various technologies to develop the mashup technology using the web service and the open API in the related art, the skeleton code generating technology according to the present invention to directly use the search result of the web service and the open API in the mashup, etc., is also insignificant.

### SUMMARY OF THE INVENTION

The present invention has been made in an effort to provide a method and an apparatus capable of integrally searching for a web service and an open API using an integrated schema in one search system.

Another object of the present invention provides a method and an apparatus for generating a block skeleton code capable of automatically generating a skeleton code by using the similarity between an integration schema for a web service and an open API and a metadata schema of a mashup block.

Yet another object of the present invention provides a method and an apparatus for generating a block skeleton code capable of directly using integrated search results for a web service and an open API using a WSDL to develop a mashup.

An exemplary embodiment of the present invention provides a method for searching for an open API and generating a mashup block skeleton code includes: storing metadata of web services and open APIs according to an integrated schema; searching for a web service or an open API corresponding to search query input from a user; extracting the metadata necessary to generate the skeleton code of the metadata of the mashup block by using the mapping relationship between the metadata of the searched web service or the searched open API and the metadata of the mashup block; and generating the skeleton code of the metadata of the mashup block by using the extracted metadata.

The method for searching for an open API and generating a mashup block skeleton code further includes generating the skeleton code of a source code of the mashup block by using the skeleton code of the generated metadata.

The integrated schema is a schema in which a new schema element written with the description contents for the open APIs not included in the description language of the web service is added or a existing schema element is modified.

The mashup block is stored and managed by metadata describing at least one of service, operation, input, output, attribute, and event that can be provided and a source code including a program logic that is called and executed.

The searching for the web service or the open API corresponding to the search query input from the user includes performing at least one of a specific range search, a weight allocating search, a previous combinable service search, a next combinable service search, and a cross combinable service search by using the metadata of the web services and the open APIs stored according to the integrated schema.

Another embodiment of the present invention provides an apparatus for searching for an open API and generating a mashup block skeleton code includes: a service storage unit that stores metadata of web services and open APIs written according to an integrated schema; a search processor that searches for a web service or an open API corresponding to a search query input from a user and extracts the metadata necessary to generate a skeleton code of the metadata of the mashup block by using the mapping relationship between the metadata of the searched web service or the searched open API and the metadata of the mashup block; and a skeleton code generator that generates the skeleton code of the metadata of the mashup block by using the extracted metadata.

The skeleton code generator generates the skeleton code of a source code of the mashup block by using the skeleton code of the generated metadata.

The integrated schema is a schema in which a new schema element written with the description contents for the open APIs not included in the description language of the web service is added or a existing schema element is modified.

The search processor performs at least one of a specific range search, a weight allocating search, a previous combinable service search, a next combinable service search, and a cross combinable service search by using the metadata of the web services and the open APIs stored according to the integrated schema.

The apparatus for searching for an open API and generating a mashup block skeleton code further includes a mashup managing unit that stores and manages the mashup block by using metadata describing at least one of service, operation, input, output, attribute, and event that can be provided and a source code including a program logic that is called and executed.

The following effects can be achieved by the present invention.

The present invention can integrally search for the web service and the open API having several formats in one search system, thereby making it possible to extend the mashup resource (web service and open API) and increase the range and availability of the mashup accordingly.

In addition, the present invention automatically generates the skeleton code of the mashup block from the web service and the open API search results, such that the web service and the open API search results can be directly used to develop the mashup, thereby making it possible to significantly reduce the time and costs consumed to develop the mashup.

### BRIEF DESCRIPTION OF THE DRAWINGS

FIG. 1 is a diagram showing an example of an open API mashup service according to the related art;

FIG. 2 is a diagram for explaining a method for authoring a mashup in a type according to the related art as shown in FIG. 1;

FIG. 3 is a diagram for explaining a configuration of an apparatus for searching for an open API and generating a mashup block skeleton code according to an exemplary embodiment of the present invention;

FIG. 4 is an example showing description contents of a web page (HTML) format;

FIG. 5 is a diagram showing an example of an integrated schema newly defined in the present invention;

FIG. 6 is a diagram showing an example of weight allocation search;

FIG. 7 is a diagram showing an example of searching pre-combinable service;

FIG. 8 is a diagram showing an example of searching post-combinable service;

FIG. 9 is a diagram showing an example of searching cross-combinable service;

FIG. 10 is a diagram showing an example of metadata for a mashup block;

FIG. 11 is a diagram showing an example of a source code for a mashup block;

FIG. 12 is an example of authoring a mashup project using a mashup block; and

FIG. 13 is a flow chart for explaining a method for searching for an open API and generating a mashup block skeleton code according to an exemplary embodiment of the present invention.

### DETAILED DESCRIPTION OF THE PREFERRED EMBODIMENTS

An exemplary embodiment of the present invention will be described below with reference to the accompanying drawings. Herein, the detailed description of a related known function or configuration that may make the purpose of the present invention unnecessarily ambiguous in describing the present invention will be omitted Exemplary embodiments of the present invention are provided so that those skilled in the art may more completely understand the present invention. Accordingly, the shape, the size, etc., of the elements in the drawings may be exaggerated for explicit comprehension.

First, the mashup means generating new software, service, database, etc., by combining information or services provided through a web. The mashup has been spotlighted as components of web 2.0.

Many examples regarding the mashup have emerged in U.S. These examples are various from matters associated with real life such as criminal statistics information, hurricane information, price information of gas stations to matters associated with hobby or entertainment such as hot spring information, UFO sighting information, site information of specific positions, etc. The development of an API that is a source of the mashup has accelerated.

For example, there is housing map by Google, which is a service provided by combining Google map with real estate information, etc. The service has advantages in that the costs to build data or the development costs are very low. The case where technologies such as the map service provided by Google, Yahoo, Microsoft, etc., product information provided by an Internet bookstore, Amazon, etc., open through the API as a web service has been increased. New services are provided by combining the independent user interface or contents, etc., with the mashup technology of the open APIs.

The mashup service means a technology generating a new service by combining two or more APIs in the web. The advantage of the mashup service cuts down efforts to implement new services by using the existing open API and can further increase the utility of the existing open API.

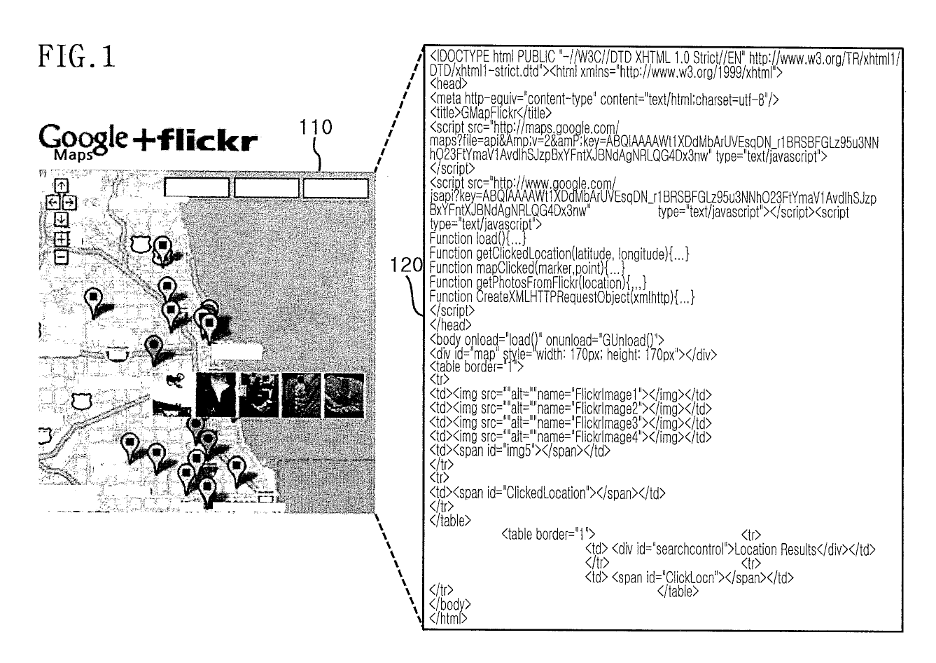

FIG. 1 is a diagram showing an example of an open API mashup service according to the related art.

A mashup 110 generated by combining photograph services from Flicker with map services by Google is shown in FIG. 1.

In this case, the mashup 110 is configured to display the photographs of the related positions on a map when the user clicks the specific positions of the map. An HTML code 120 of the mashup 110 is shown at the right side of FIG. 1.

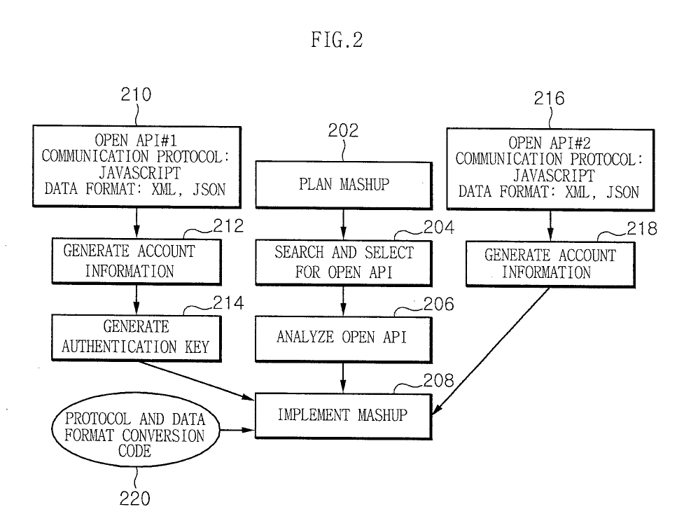

FIG. 2 is a diagram for explaining a method for authoring a mashup as a type according to the related art, as shown in FIG. 1.

Referring to FIG. 2, the mashup developer plans what type of mashup is produced (202). Then, open APIs 210 and 216 to be used to produce the planned mashup is searched and selected (204).

If it is determined that the mashup developer wishes to produce the mashup service using the Google map open API and the Flicker open API, the mashup developer analyzes the Google map open API and the Flicker open API to determine the characteristics of the open API services (for example, communication protocol, data format, and type of input and output data, etc.) (206). The open API service provider generates the user account information 212 and 218 or the user authentication key 214 and provides them to the developer.

The mashup developer secures the open API and refers to a manual provided by the open API service providers to implement the mashup function and determines the layout of the HTML page to complete the final mashup contents (208).

Therefore, there is a problem in that the mashup developer is in charge of the portions related to the mashup implementation such as data format conversion and communication protocol. (220).

In particular, since the method for providing the open API service is different for each open API service provider, there is a problem in that the developer should first acquire the analysis and related technology for various open API services and the mashup depends on the ability of the developer.

Further, since the related code or the script of the open API configuring the mashup is randomly produced by the developer, it is difficult to update the open API configuring the mashup and add a new open API to the existing mashup.

The present invention is to solve the above-mentioned problem. A method for automatically generating a skeleton code by using the similarity between the schema for the web service and the open API and the mashup block schema is provided so that the searched web service and the results of searching the open API can be used in developing the mashup.

Referring to the drawings, a method and an apparatus for searching for the open API and generating the mashup block skeleton code according to the present invention will be described in detail below.

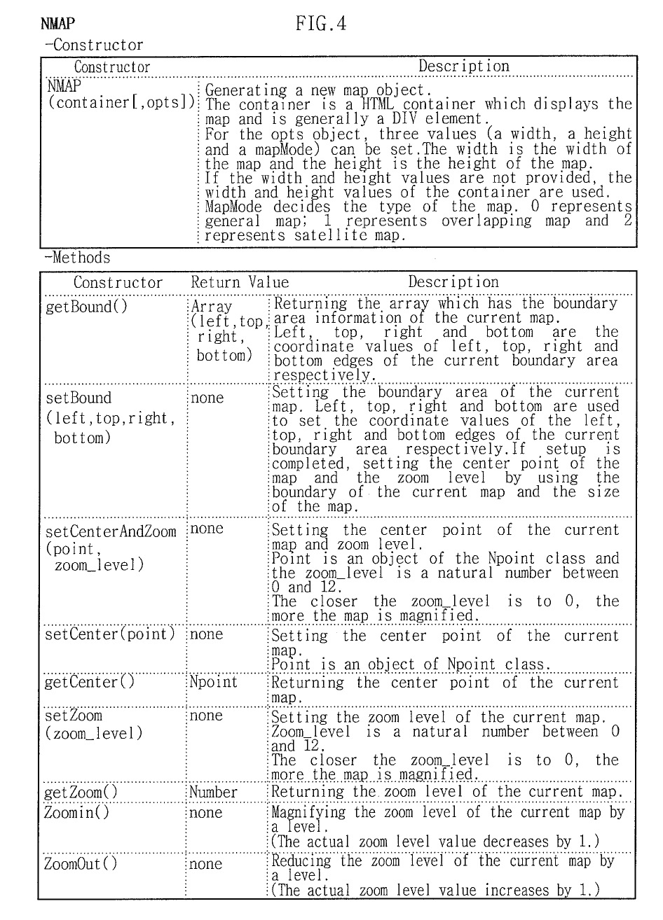

First, the present invention changes the WSDL in the description type of the existing SOAP type web service into the new integrated schema. At the same time, the integrated schema for the open APIs of several types and several sites is defined from the description contents in a web HTML type as shown in FIG. 4 for the open APIs in several type such as REST, Javascript RSS/ATOM, etc., serviced by several sites (for example, Google, Yahoo, etc.). The WSDL is the web service description type, and a process of changing the WSDL into a new integrated schema includes a process of adding a new schema element recorded with the description contents for the open APIs in several types that is not included in the WDSL of the web service or modifying the existing schema element.

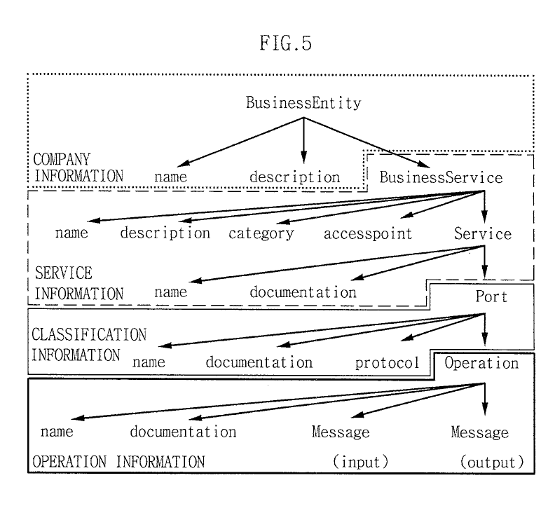

In other words, the present invention defines the schema for the web service and the open API as one integrated schema to provide a method for searching for the web service and the open API in one searching system. FIG. 5 is a diagram showing an example of an integrated schema newly defined in the present invention. The present invention is devised based on the fact that the schema of the web service is considerably similar to the schema of the open API in view of a type that defines a provider, service classification, an individual service, an operation, an input, and an output, etc.

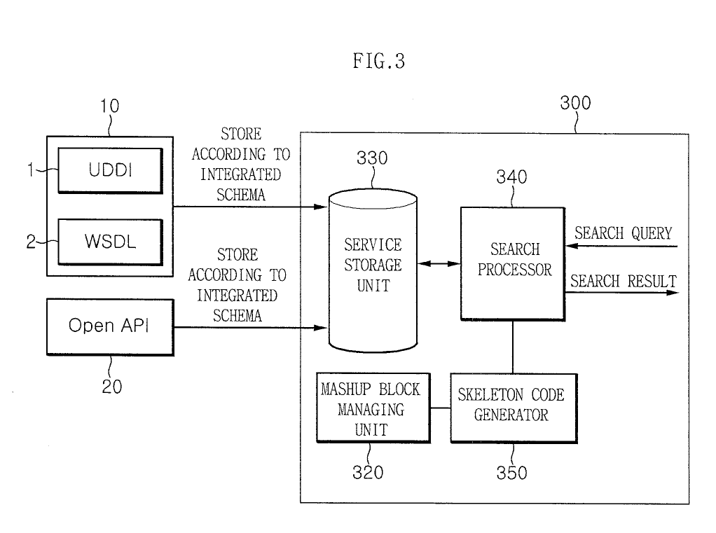

FIG. 3 is a diagram for explaining a configuration of an apparatus for searching for an open API and generating a mashup block skeleton code according to an exemplary embodiment of the present invention.

Referring to FIG. 3, an apparatus 300 for searching for an open API and generating a mashup block skeleton code according to the present invention includes a service storage unit 330, a search processor 340, a skeleton code generator 350, and a mashup block managing unit 320.

The service storage unit 330 stores and manages the metadata of web services and open APIs written according to the integrated schema. The integrated schema for the web service and open API may be defined based on the similarity of a type defining provider, service classification, individual service, operation, input, output, etc. For example, it may be defined as shown in FIG. 5. The integrated schema defined as described above is very similar to the schema of metadata of the mashup block that is an object of the mashup. The metadata of the web services and the open APIs stored in the service storage unit 330 are used when searching for a web service or an open API.

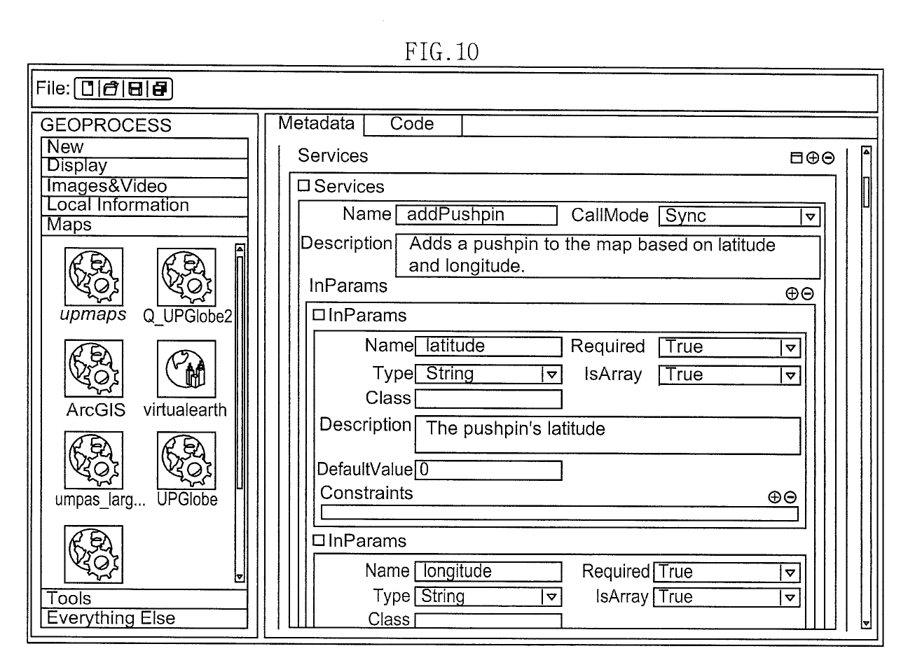

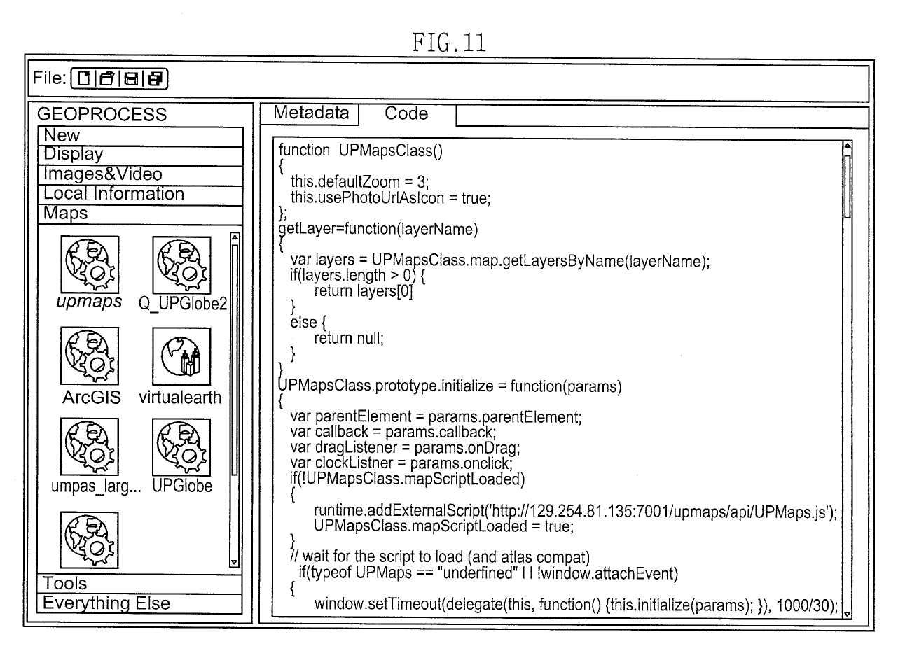

The mashup block managing unit 320 stores and manages the mashup blocks having the skeleton code generated through the skeleton code generator 350. In this case, the mashup managing unit 320 stores and manages the mashup blocks by metadata describing service, operation, input, output, attribute, and event that can be provided by the mashup block and a source code including a program logic that is called and executed, when managing the mashup block. FIGS. 10 and 11 show an example of the metadata and the source code for the mashup block, respectively.

The search processor 340 searches for the web service or the open API corresponding to the searching query input from the user and extracts the information (metadata) necessary to generate the skeleton code of the metadata of the corresponding mashup block by using the mapping relationship between the metadata of the searched web service or the open API and the metadata of the mashup block that is an object of the mashup from the service storage unit 330.

Since the search processor 340 uses the newly defined integrated schema to perform the search, it can search sub-steps such as individual service, operation, input, and output, etc., of the web service and the open API.

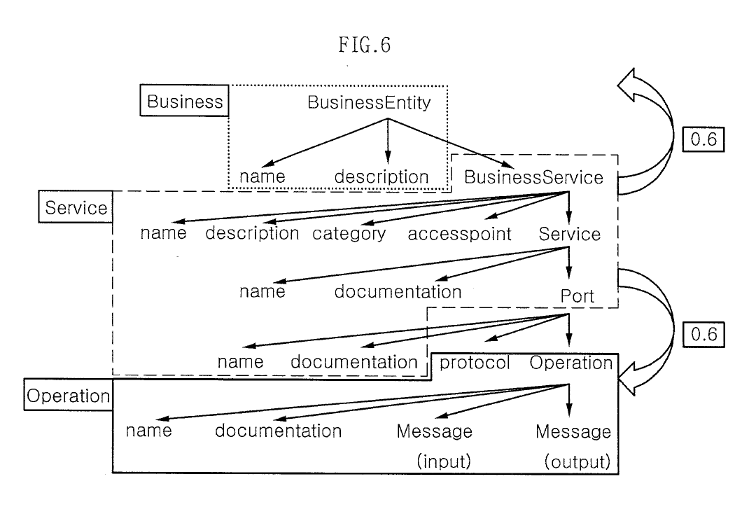

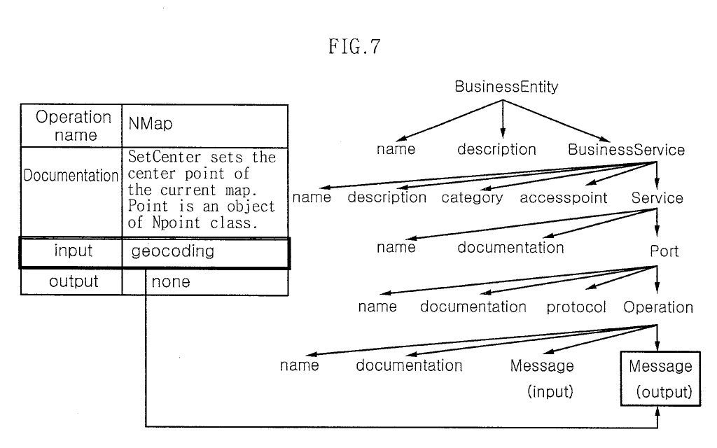

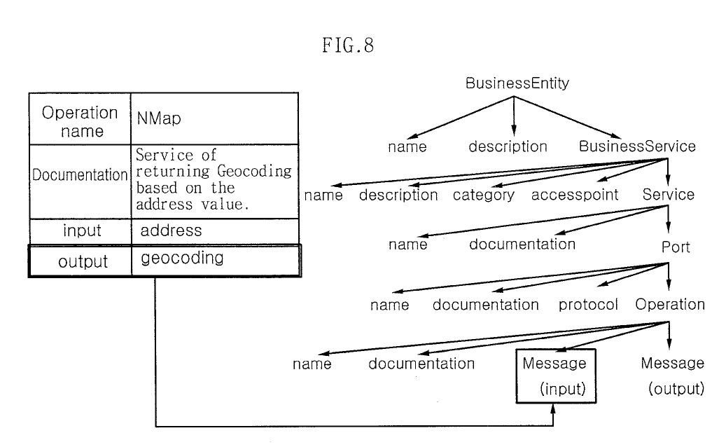

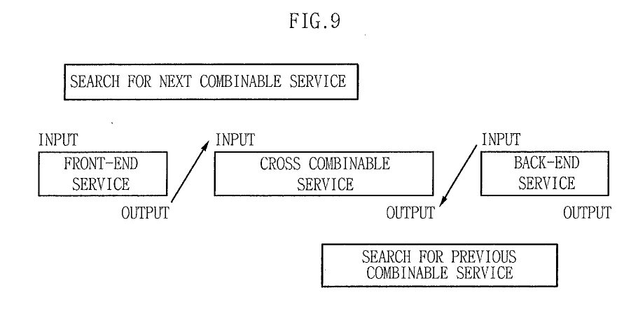

Therefore, the search processor 340 according to the present invention can perform the specific range search, the weight allocating search (see FIG. 6), the previous combinable service search (see FIG. 7), the next combinable service search (see FIG. 8), the cross combinable service search (see FIG. 9), etc.

Meanwhile, the skeleton code generator 350 uses the information extracted through the search processor 340 to generate the skeleton code of the metadata of the mashup block that is the object of the mashup. The skeleton code generator 350 uses the skeleton code of the generated metadata to generate the skeleton code of the source code of the mashup block.

The apparatus of the present invention can integrally search for the web service and the open API in several types in one search system, thereby making it possible to extend the mashup resource and increase the range and availability of the mashup development accordingly. In addition, the present invention automatically generates the skeleton code of the mashup block from the web service and the open API search results, such that the web service and the open API search results can be directly used to develop the mashup, thereby making it possible to significantly reduce the time and costs consumed to develop the mashup.

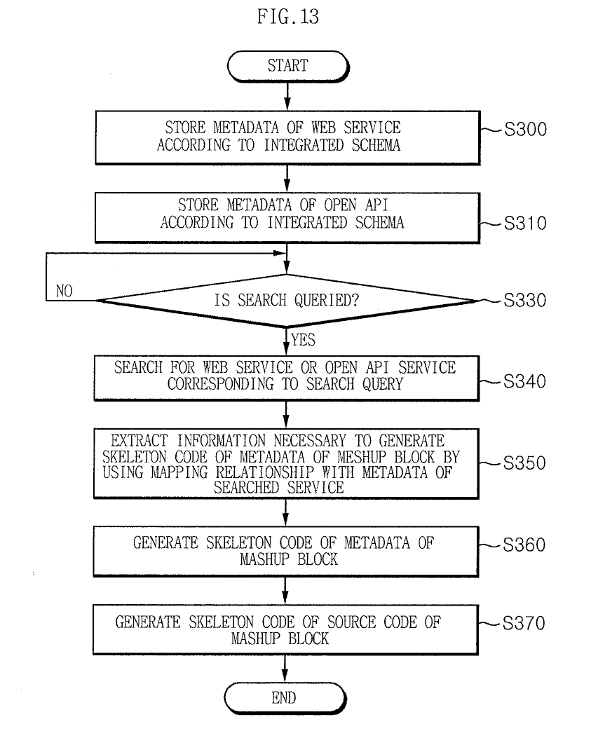

FIG. 13 is a flow chart for explaining a method for searching for an open API and generating a mashup block skeleton code according to an exemplary embodiment of the present invention.

Referring to FIG. 13, it stores the metadata of the WSDL that is the description type of the web services in the existing SOAP type according to the integrated schema (S300). At the same time, the integrated schema for the metadata of the open APIs of several types and several sites is kept and stored from the description contents in a web HTML format as shown in FIG. 4 for the open APIs in several type such as REST, Javascript RSS/ATOM, etc., serviced by several sites (for example, Google, Yahoo, etc.) (S310). As described above, the integrated schema means a schema in which a new schema element written with the description contents for the open APIs not included in the description language of the web service is added or the existing schema element is modified.

Through steps S300 and S310, if the metadata of the web services and the open APIs written according to the integrated schema are stored and the search query is input from the user (S330), the web service or the open API corresponding to the search query input from the user are searched and the information (metadata) necessary to generate the skeleton code of the metadata of the mashup block by using the mapping relationship between the metadata of the searched web service or the open API and the metadata of the mashup block is extracted from the service storage unit (S340 and S350).

If the metadata is extracted through step S350, the search processor transfers the extracted information to the skeleton code generator and the skeleton code generator uses the extracted information to generate the skeleton code of the metadata of the corresponding mashup block (S360).

Further, the skeleton code generator uses the skeleton code of the metadata generated through step S310 to generate the skeleton code of the source code of the mashup block (S370).

Each step shown in FIG. 13 may be performed by the apparatus for searching for the open API and generating the mashup block skeleton code.

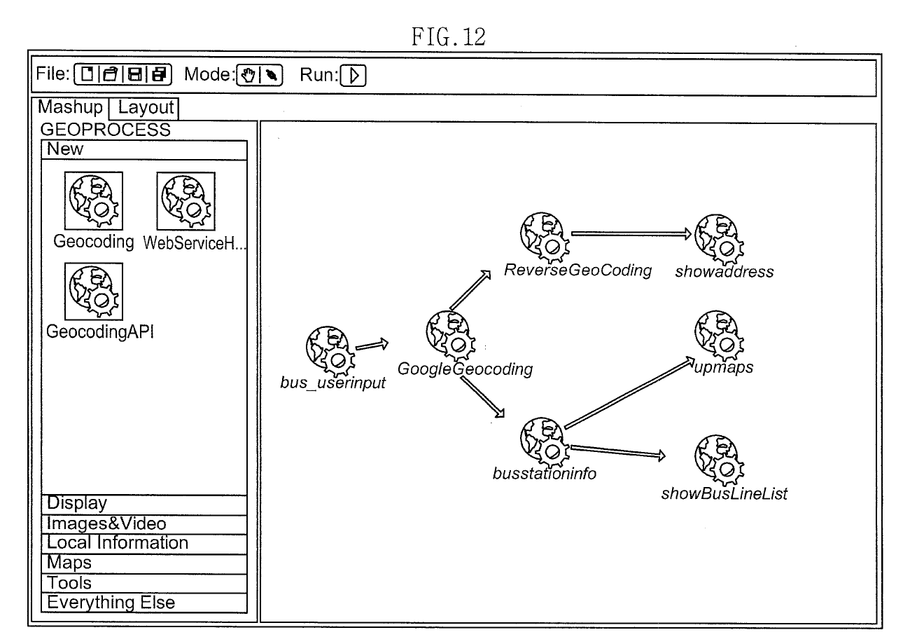

FIG. 12 is a diagram showing an exemplary embodiment authoring the mashup project by using the mashup block generated through the above-mentioned process.

With the present invention, it can develop the new mashup service through the additional block authoring and the mashup project authoring on the skeleton contents as well as integrally search for the web service and the open API in several types in one search system.

As described above, the exemplary embodiments have been described and illustrated in the drawings and the description. Herein, specific terms have been used, but are just used for the purpose of describing the present invention and are not used for qualifying the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A method for searching for an open API and generating a mashup block skeleton code, comprising:
storing metadata of web services and open APIs according to an integrated schema;
searching for a web service or an open API corresponding to search query input from a user;
extracting the metadata necessary to generate the skeleton code of the metadata of the mashup block by using the mapping relationship between the metadata of the searched web service or the searched open API and the metadata of the mashup block; and
generating the skeleton code of the metadata of the mashup block by using the extracted metadata.

2. The method for searching for an open API and generating a mashup block skeleton code according to claim 1, further comprising generating the skeleton code of a source code of the mashup block by using the skeleton code of the generated metadata.

3. The method for searching for an open API and generating a mashup block skeleton code according to claim 1, wherein the integrated schema is a schema in which a new schema element written with the description contents for the open APIs not included in the description language of the web service is added or a existing schema element is modified.

4. The method for searching for an open API and generating a mashup block skeleton code according to claim 1, wherein the mashup block is stored and managed by metadata describing at least one of service, operation, input, output, attribute, and event that can be provided and a source code including a program logic that is called and executed.

5. The method for searching for an open API and generating a mashup block skeleton code according to claim 1, wherein the searching for the web service or the open API corresponding to the search query input from the user includes performing at least one of a specific range search, a weight allocating search, a previous combinable service search, a next combinable service search, and a cross combinable service search by using the metadata of the web services and the open APIs stored according to the integrated schema.

6. An apparatus for searching for an open API and generating a mashup block skeleton code, comprising:
a service storage unit that stores metadata of web services and open APIs written according to an integrated schema;
a search processor that searches for a web service or an open API corresponding to a search query input from a user and extracts the metadata necessary to generate a skeleton code of the metadata of the mashup block by using the mapping relationship between the metadata of the searched web service or the searched open API and the metadata of the mashup block; and
a skeleton code generator that generates the skeleton code of the metadata of the mashup block by using the extracted metadata.

7. The apparatus for searching for an open API and generating a mashup block skeleton code according to claim 6, wherein the skeleton code generator generates the skeleton code of a source code of the mashup block by using the skeleton code of the generated metadata.

8. The apparatus for searching for an open API and generating a mashup block skeleton code according to claim 6, wherein the integrated schema is a schema in which a new schema element written with the description contents for the open APIs not included in the description language of the web service is added or a existing schema element is modified.

9. The apparatus for searching for an open API and generating a mashup block skeleton code according to claim 6, wherein the search processor performs at least one of a specific range search, a weight allocating search, a previous combinable service search, a next combinable service search, and a cross combinable service search by using the metadata of the web services and the open APIs stored according to the integrated schema.

10. The apparatus for searching for an open API and generating a mashup block skeleton code according to claim 6, further comprising a mashup managing unit that stores and manages the mashup block by using metadata describing at least one of service, operation, input, output, attribute, and event that can be provided and a source code including a program logic that is called and executed.
